(19) United States
(12) Patent Application Publication
(10) Pub. No.: US 2024/0088711 A1
(43) Pub. Date: Mar. 14, 2024

(54) POWER REGULATION IN WIRELESS POWER TRANSMITTER

(71) Applicants: STMicroelectronics Asia Pacific Pte Ltd., Singapore (SG); STMicroelectronics International N.V., Geneva (CH)

(72) Inventors: Baranidharan Karuppusamy, Singapore (SG); Abhay Jaisen Bhanushali, Singapore (SG)

(21) Appl. No.: 17/941,199

(22) Filed: Sep. 9, 2022

(51) Int. Cl. H02J 50/10; H02J 7/00; H02J 50/80

(52) U.S. Cl. CPC H02J 50/10; H02J 7/00711; H02J 7/00712; H02J 50/80; H02J 2207/20

(57) ABSTRACT

A method for operating a wireless power transmitter includes: receiving a power control command from a wireless power receiver; computing a potential voltage change for a transmitter voltage of the wireless power transmitter in accordance with a target transmitter power and a present value of a transmitter current of the wireless power transmitter; comparing the potential voltage change with a discrete step size of a supply voltage; and in response to determining that the magnitude of the potential voltage change is equal to or larger than the discrete step size of the supply voltage, adjusting the transmitter power by: adjusting the supply voltage by one or more discrete steps; and controlling a power conversion circuit of the wireless power transmitter using a target current value computed in accordance with the target transmitter power and the adjusted supply voltage.

### TECHNICAL FIELD

The present invention relates generally to methods and devices for wireless charging.

### BACKGROUND

Wireless charging is becoming widely used recently to charge electronic devices including, but not limited to, mobile phones, smart watches, and tablets. A wireless power-receiving device (also referred to as a wireless power receiver) is electromagnetically coupled with a wireless power-transmitting device (also referred to as a wireless power transmitter). During the power transfer, communication between the wireless power-receiving device and the wireless power-transmitting device may be used to adjust the power received at the wireless power-receiving device. Communication may be achieved by varying an internal load of a receiving circuit of the wireless power-receiving device to produce an Amplitude Shift Keying (ASK) signal.

Various industry standards have been developed to specify the protocol between the wireless power transmitters and wireless power receiver, such as how the wireless power transmitters and wireless power receiver communicate with each other to adjust for supply and demand of power. For example, the Qi wireless charging standard defined by the Wireless Power Consortium (WPC) uses in-band communication within the transformer (e.g., transmitter coil and receiver coil) while the AirFuel protocol defined by the AirFuel Alliance uses out-of-band communication through Bluetooth, Near-Field Communication, and so on.

For devices with small rechargeable batteries, caution needs to be exercised for power transfer between the wireless power transmitter and the wireless power receiver, in order to achieve linear and finer power regulation to avoid stressing the battery charging system. There is a need in the art for wireless charging systems that is simple and cost effective, while providing linear and finer power regulation.

### SUMMARY

In some embodiments, a method for operating a wireless power transmitter includes: receiving a power control command from a wireless power receiver inductively coupled to the wireless power transmitter; computing a target transmitter power for the wireless power transmitter in accordance with the power control command; computing a potential voltage change for a transmitter voltage of the wireless power transmitter in accordance with the target transmitter power; determining if a magnitude of the potential voltage change is equal to or larger than a discrete step size of a supply voltage provided by a power supply, wherein the power supply is coupled to the wireless power transmitter and configured to provide the supply voltage to the wireless power transmitter; and in response to determining that the magnitude of the potential voltage change is equal to or larger than the discrete step size of the supply voltage, adjusting a transmitter power of the wireless power transmitter by: setting the supply voltage provided by the power supply to a first voltage value by changing the supply voltage by one or more discrete steps; computing a first target current value for a transmitter current of the wireless power transmitter in accordance with the target transmitter power and the first voltage value; and controlling a power conversion circuit of the wireless power transmitter using the first target current value, wherein the power conversion circuit is coupled to a coil of the wireless power transmitter, and is configured to provide an alternate current (AC) voltage to the coil of the wireless power transmitter.

In some embodiments, a method for operating a wireless power transmitter includes: receiving, by the wireless power transmitter, a power control command from a wireless power receiver, wherein the wireless power transmitter comprises a power conversion circuit, wherein the power conversion circuit is coupled to a Direct Current (DC) power supply and is configured to convert a DC voltage provided by the DC power supply into an Alternate Current (AC) voltage applied to a coil of the wireless power transmitter, wherein the DC voltage provided by the DC power supply changes in discrete steps and has a discrete step size; computing a target transmitter power for the wireless power transmitter in accordance with the power control command; computing, based on the target transmitter power and a present value of a transmitter current of the wireless power transmitter, a potential voltage change for a transmitter voltage of the wireless power transmitter in order to achieve the target transmitter power; determining if a magnitude of the potential voltage change is equal to or larger than the discrete step size of the DC power supply; and in response to determining that the magnitude of the potential voltage change is equal to or larger than the discrete step size of the DC power supply, adjusting a transmitter power of the wireless power transmitter by: shifting the DC voltage provided by the DC power supply by one or more discrete steps such that the DC voltage has a first voltage value; computing a first target current value for the transmitter current of the wireless power transmitter based on the target transmitter power and the first voltage value; and controlling the power conversion circuit using the first target current value.

In some embodiments, a wireless power transmitter includes: a coil; a power conversion circuit coupled to the coil, wherein the power conversion circuit is configured to receive a Direct Current (DC) voltage from a power supply and convert the DC voltage to an Alternate Current (AC) voltage applied to the coil, wherein DC voltage provided by the power supply is adjustable in discrete steps and has a discrete step size; a communication circuit coupled to the coil and configured to receive a power control command from a wireless power receiver; and a controller coupled to the power conversion circuit and the communication circuit, wherein the controller is configured to: receive the power control command from the communication circuit; compute a target transmitter power for the wireless power transmitter in accordance with the power control command; compute, based on the target transmitter power and a present value of a transmitter current of the wireless power transmitter, a potential voltage change for a transmitter voltage of the wireless power transmitter; compare the potential voltage change with the discrete step size of the power supply; and in response to determining that a magnitude of the potential voltage change is equal to or larger than the discrete step size of the power supply, adjust a transmitter power of the wireless power transmitter by: shifting the DC voltage provided by the power supply by one or more discrete steps such that the DC voltage has a first voltage value; computing a first target current value for the transmitter current of the wireless power transmitter based on the target transmitter power and the first voltage value; and controlling the power conversion circuit using the first target current value.

### BRIEF DESCRIPTION OF THE DRAWINGS

The details of one or more embodiments of the invention are set forth in the accompanying drawings and the description below. Other features, objects, and advantages of the invention will be apparent from the description and drawings, and from the claims. In the figures, identical reference symbols generally designate the same component parts throughout the various views, which will generally not be re-described in the interest of brevity. For a more complete understanding of the invention, reference is now made to the following descriptions taken in conjunction with the accompanying drawings, in which:

FIG. 1 illustrates a block diagram of wireless charging system, in an embodiment;

FIG. 2 illustrates a flow chart of a method for operating a wireless power transmitter, in an embodiment;

FIG. 3 illustrates a block diagram of a digital signal processing system, in an embodiment;

FIGS. 4 and 5 illustrate performance of wireless charging systems without and with the presently disclosed method of operating the wireless power transmitter, respectively, in an embodiment; and

FIG. 6 illustrates a flow chart of a method for operating a wireless power transmitter, in an embodiment.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described in the context of wireless charging, and in particular embodiments, methods and circuits for wireless power transmitters.

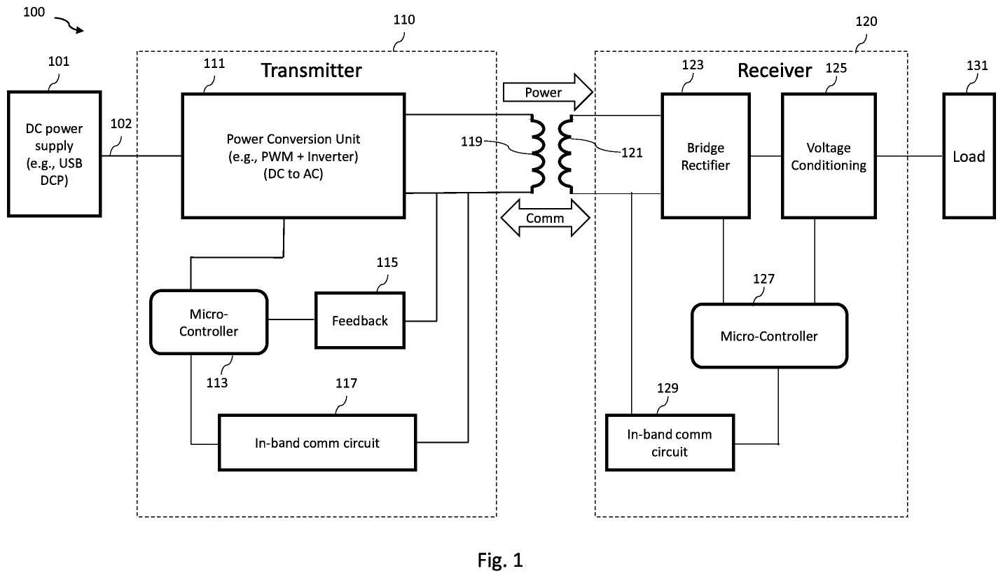

FIG. 1 illustrates a block diagram of wireless charging system 100, in an embodiment. As shown in FIG. 1, the wireless charging system 100 includes a wireless power transmitter 110 and a wireless power receiver 120. The wireless power transmitter 11o has a coil 119, which is inductively coupled to a coil 121 of the wireless power receiver 120.

In the example of FIG. 1, the wireless power transmitter 11o is coupled to a power source 101 (also referred to as a power supply). In some embodiments, the power source 101 is a Direct Current (DC) power supply that provides a DC voltage to power the wireless power transmitter 11o. The power source 101 may be, e.g., a Universal Serial Bus-Dedicated Charging Port (USB-DCP) power supply. Details of USB-DCP are described in the USB-Battery Charging (USB-BC) standard. In an example embodiment, the power source 101 is a USB-Quick Charge (USB-QC) power supply, where the USB-QC standard falls under the USB-BC standard. In some embodiments, the power source 101 (e.g., a USB-QC power supply) is plugged into a power outlet (e.g., a wall socket) and provides a DC voltage within a specific range (e.g., +5V to +12V). In some embodiments, the DC voltage provided by the power source 101 is adjustable in discrete steps having a discrete step size (e.g., 200 mV). The wireless power transmitter 110 may request a specific DC voltage from the power source 101 through a data line in a signal/data path 102 (e.g., for transmitting voltage signal(s) and digital data) between the power source 101 and the wireless power transmitter 110. For example, an USB-QC power supply may provide a DC voltage that is adjustable in discrete steps with a discrete step size of 200 mV.

In FIG. 1, the wireless power transmitter 110 includes a power conversion circuit 11, a controller 113, a feedback circuit 115, an in-band communication circuit 117, and the coil 119. In some embodiments, the power conversion circuit 11 includes a Pulse Width Modulation (PWM) circuit and a power converter. The PWM circuit is configured to generate a PWM signal having a frequency and a duty cycle. The PWM signal drives the power converter of the power conversion circuit 11, which power converter may be, e.g., a DC-AC power converter that converts the DC voltage provided by the power source 101 into an Alternate Current (AC) voltage, where the AC voltage is applied to the coil 119 for wireless power transfer. In some embodiments, the output power (may also be referred to as the transmitter power) of the wireless power transmitter 11o, which is equal to the multiplication of the voltage across the coil 119 (also referred to as transmitter voltage) and the current flowing through the coil 119 (also referred to as transmitter current), may be adjusted by adjusting the frequency or the duty cycle of the PWM signal driving the power converter of the power conversion circuit 111. In addition, the transmitter power may be adjusted by adjusting the DC voltage provided to the power conversion circuit in by the power source 101. Note that in the discussion herein, the word “or” is used in a non-exclusive context. For example, in the above discussion, the output power of the wireless power transmitter 110 is said to be adjustable by adjusting the frequency or the duty cycle of the PWM signal, which means that the output power of the wireless power transmitter 110 is adjustable by adjusting the frequency of the PWM signal, by adjusting the duty cycle of the PWM signal, or by adjusting both the frequency and the duty cycle of the PWM signal.

Although not illustrated in FIG. 1, the wireless power transmitter 110 may include a rechargeable battery that is charged by the power conversion circuit 111. The rechargeable battery may replace the power source 101 as the DC power supply during wireless charging, when the power source 101 is not available. This may be useful in applications where a mobile device (e.g., a mobile phone) wirelessly charges another mobile device (e.g., another mobile phone, True Wireless earbuds, or the like).

The coil 119, which may also be referred to as the primary coil or transmitter coil, is inductively coupled (e.g., electromagnetically coupled) to the coil 121 (may also be referred to as a secondary coil or receiver coil) of the wireless power receiver 120. The AC current flowing through the transmitter coil 119 create a time-varying (e.g., an oscillating) electromagnetic field and induces a current in the wireless power receiver 120. The current induced in the wireless power receiver 120 may then be utilized for charging a load 131 (e.g., a rechargeable battery) coupled to the wireless power receiver 120.

The feedback circuit 115 of the wireless power transmitter 11o is coupled to the coil 119 and is configured to measure the transmitter current and the transmitter voltage. The in-band communication circuit 117 is coupled to the coil 119 is configured to perform in-band communication between the wireless power transmitter 11o and the wireless power receiver 120.

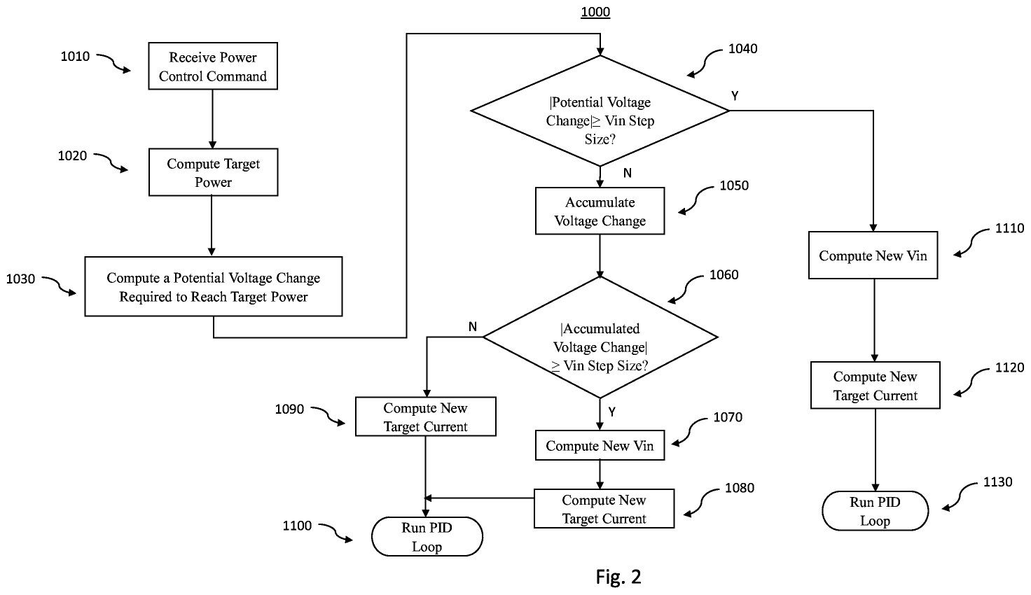

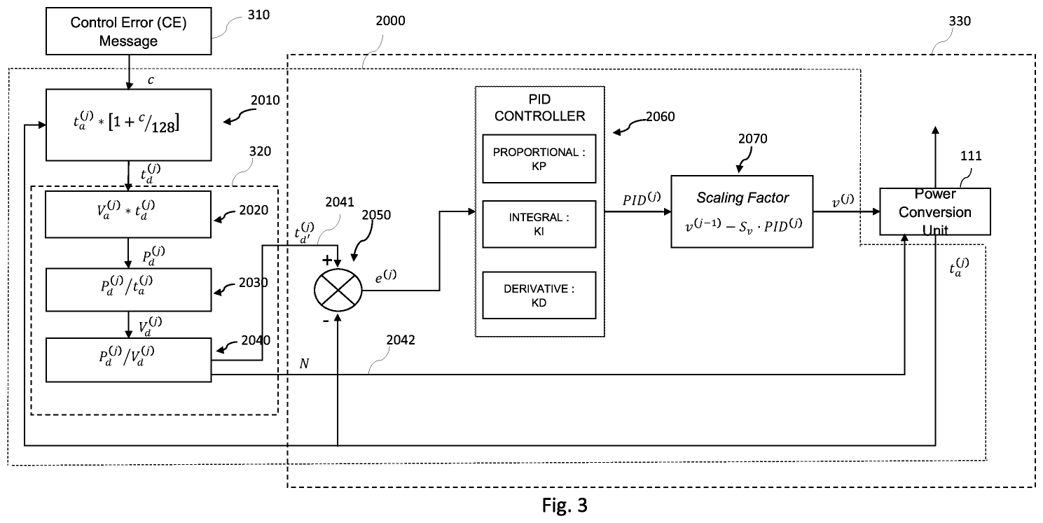

The controller 113 may be a micro-controller, a processor, an Application Specific Integrated-Circuit (ASIC), or the like, and is used to control operation of the wireless power transmitter 110. In some embodiments, the controller 113 includes a memory module (e.g., a non-volatile memory) that stores instructions (e.g., computer codes), which when executed by the controller 113, performs signal processing functions and generates control signals/data signals that are used to control the operation of the wireless power transmitter 110. For example, the controller 113 may perform the signal processing functions illustrated in FIG. 3. The controller 113 may generate control signals/data signals that is used to control the wireless power transmitter 110 in accordance with the method 1000 of FIG. 2. Details are discussed hereinafter.

Stilling referring to FIG. 1, the wireless power receiver 120 includes the coil 121, a rectifier circuit 123, a voltage conditioning circuit 125, an in-band communication circuit 129, and a controller 127. In some embodiments, the rectifier circuit 123 rectifies (e.g., converts) the AC voltage induced across the coil 121 into a DC voltage. The rectifier circuit 123 may be any suitable rectifier, such as a full-bridge rectifier, a half-bridge rectifier, or the like. The DC voltage generated by the rectifier circuit 123 is conditioned by the voltage condition circuit 125 to provide a stable DC voltage for the load 131 (e.g., a rechargeable battery of a mobile device). The voltage condition circuit 125 may include a DC-DC power converter and a voltage regulator (e.g., a Low-Dropout (LDO) voltage regulator), as an example.

In some embodiments, the in-band communication circuit 129 of the wireless power receiver 120 communicates with the in-band communication circuit 117 of the wireless power transmitter 11o through Amplitude Shift Keying (ASK) modulation. In some embodiments, the in-band communication circuit 129 includes a capacitor and a switch that are coupled in parallel to an internal load. The switch, under the control of the controller 127, is switched between an “On” state and an “Off” state to connect or disconnect the capacitor from the internal load, which causes a change in the amplitude of the AC voltage across the coil 121. The change in the amplitude of the AC voltage across the coil 121 is sensed by the transmitter coil 119 (e.g., through electromagnetic coupling) and decoded by the in-band communication circuit 117.

The controller 127 of the wireless power receiver 120 may be a micro-controller, a processor, an Application Specific Integrated-Circuit (ASIC), or the like, and is used to control operation of the wireless power receiver 120. In some embodiments, the controller 127 includes a memory module (e.g., a non-volatile memory) that stores instructions (e.g., computer codes), which when executed by the controller 127, performs signal processing functions and generates control signals/data signals that are used to control the operation of the wireless power receiver 120. In some embodiments, the controller 127 monitors the output of the rectifier circuit 123 and/or the output of the voltage conditioning circuit 125, and based on, e.g., the DC voltage provided to the load 131, generates a power control command for the wireless power transmitter 110. The power control command is sent via the in-band communication circuits 129/117 using ASK modulation, in some embodiments.

In the illustrated embodiment, the power control command is a request for the wireless power transmitter 110 to increase or decrease the transmitted power by a percentage. For example, the power control command may indicate a control message of “power up by X percentage” or “power down by Y percentage.” In some embodiments, due to, e.g., coupling loss between the wireless power transmitter 11o and the wireless power receiver 120, it may be difficult to send a request for a specific value (e.g., an absolute value) of the transmitter power in the power control command. The power change in percentage is a simple and flexible way to request a change in the transmitted power. Typically, a first power control command is followed by a few subsequent power control commands, in order for the transmitted power to be adjusted and approach the desired value.

Rechargeable-battery-operated wearable consumer electronic devices, such as smart-watch and True Wireless (TWS) earbuds, are now using wireless power delivery to charge the batteries of the devices. Typically, these wearable device batteries have capacity under 1000 mAh, and while charging, the charging power should be regulated precisely, since sudden or instantaneous surges in charging power may result in battery damage.

The wireless power transmitters used for recharging wearable device batteries may perform power regulation by changing operating frequency (of the PWM signal), duty-cycle (of the PWM signal), or supply voltage (e.g., provided to the power conversion circuit 111). Due to the small form factor of wearable devices, the receiver coils used on these devices have smaller areas. Due to the small area of the receiver coil, it may not be possible to achieve smooth power regulation by adjusting only the operating frequency and the duty-cycle of the wireless power transmitter, and it may be necessary to control the supply voltage as well.

To control supply voltage smoothly, DC-DC converters are generally used. However, DC-DC converters generally require bulky inductors, and considering the form factors of the wearable devices, those bulky inductors may not be used. Moreover, these bulky inductors will add extra component cost to the wireless power transmitter. Another unwanted side-effect of using DC-DC converters is that it may generate heat at the surface of the wireless power transmitter, which may be closely located to the battery of the wireless power transmitter and could potentially increase the battery temperature.

A potential solution to avoid using DC-DC converter in the wireless power converter but still be able to control supply voltage is to use a variable power supply such as a USB wall-adapter. Low-end USB wall-adapters, such as USB-DCP or USB-QC adaptors, are inexpensive and widely used for mobile device charging, but these USB wall-adapters usually have coarse voltage step size of, e.g., 200 mV compared to few mV for DC-DC converters. Adjusting supply voltage provided by these USB wall-adapters in coarse discrete step size (e.g., 200 mV) may create power spike at the wireless power receiver and may damage the battery of the wireless power receiver. High-end USB power adapters, such as USB-Power Delivery Programmable Power Supply (USB-PD PPS) power supplies, allows more precise voltage change in discrete step size of 20 mV and may be able to provide smooth control of supply voltage. However, the USB-PD PPS adapter has complex circuit design and incurs higher cost.

The present disclosure provides a solution that allows the use of the low-end USB wall-adapters (e.g., USB-QC adapters) with coarse voltage step size (e.g., 200 mV) as the power source 101 of FIG. 1, and still achieve smooth power regulation. The wireless power transmitter 110 used in the disclosed solution has low complexity. The controller 113, by performing the signal processing functions of FIG. 3 and by controlling the wireless power transmitter 110 (and the power source 101) in accordance with the method of FIG. 2, achieves smooth power regulation. Details are discussed hereinafter.

FIG. 2 illustrates a flow chart of a method 1000 for operating a wireless power transmitter, in an embodiment. The method 1000 may be used to control operation of the wireless power transmitter 110 of FIG. 1. In particular, the method 1000 shows the operation performed by the wireless power transmitter 110 in response to a power control command. As discussed previously, during operation of the wireless charging system 100, the wireless power receiver 120 may send multiple power control commands, one after another, in order to fine-tune the transmitter power of the wireless power transmitter 11o, such that smooth power regulation at the wireless power receiver 120 is achieved for charging the battery of the wireless power receiver 120. Discussion of the method 1000 refers to various devices/circuits in the wireless charging system 100 of FIG. 1.

In FIG. 2, at block 1010, a power control command is received by the wireless power transmitter 11o from the wireless power receiver 120. The power control command comprises a request of transmitter power adjustment, such as “power up by X percentage” or “power down by Y percentage,” in some embodiments.

Next, at block 1020, the wireless power transmitter 110 computers a target power P_{TARGET} (also referred to as a target transmitter power). The controller 113 computes the target transmitter power P_{TARGET} by adjusting (e.g., increasing or decreasing) the present transmitter power by the required percentage. For example, the controller 113 has knowledge about the present value of the transmitter current (e.g., current flowing in the transmitter coil 119) and the present value of the transmitter voltage (e.g., voltage across the transmitter coil 119), which present values may be provided by the feedback circuit 115. In an embodiment, the controller 113 adjusts the present value of the transmitter current by the requested percentage to obtain a modified transmitter current value, then multiplies the modified transmitter current value with the present value of the transmitter voltage to compute the target transmitter power P_{TARGET}. Other ways to compute the target transmitter power are possible, and are fully intended to be included within the scope of the present disclosure. In the discussion herein, the “present value” of the transmitter voltage (or transmitter current) refers to the value of the transmitter voltage (or transmitter current) when the power control command is received and before the wireless power transmitter 110 adjusts the transmitter voltage (or transmitter current) in response to the power control command received currently.

Next, at block 1030, a potential voltage change ΔV to achieve the target transmitter power P_{TARGET} is calculated. In some embodiments, the calculation of the potential voltage change ΔV is performed by dividing the target transmitter power P_{TARGET} by the present value of the transmitter current to find a potential target voltage V_{TARGET}, then subtract the present value of the transmitter voltage from the potential target voltage V_{TARGET}. In other words, the potential voltage change ΔV represents a voltage change needed to achieve the target transmitter power P_{TARGET}, assuming that the transmitter current remains at the present value.

Next, at block 1040, the potential voltage change ΔV is compared with the discrete step size of the power source 101. In embodiments where an USB-QC power supply is used as the power source 101, the discrete step size is 200 mV. Denote the discrete step size of the power source 101 as V_{STEP}, the processing of the block 1040 compares the magnitude (e.g., the absolute value |ΔV|) of the potential voltage change ΔV with the discrete step size V_{STEP} of the power source 101, in order to determine if the magnitude of the potential voltage change ΔV is equal to or larger than the discrete step size V_{STEP}.

If the magnitude of the potential voltage change ΔV is equal to or larger than the discrete step size V_{STEP}, the processing of the method 1000 proceeds to block 1110, where a new voltage value V_{IN} is computed for the output voltage of the power source 101 (which is the input voltage for the power conversion circuit 11 of the wireless power transmitter 110). In an example embodiment, the new voltage value V_{IN} differs from the presently value of the output voltage of the power source 101 by N discrete step sizes V_{STEP}, where N is an integer. A positive integer number of N indicates that the output voltage of the power source 101 should be increased by N discrete steps, and a negative integer number of N indicates that the output voltage of the power source 101 should be decreased by N discrete steps. Denote the present value (e.g., the value before changing by N discrete steps) of the output voltage of the power source 101 as V_{IN_OLD}, the new voltage value V_{IN} is represented by:

V_{IN}=V_{IN_OLD}+N×V_{STEP} (1)

In some embodiments, the integer number N is determined by dividing the potential voltage change ΔV by the discrete step size V_{STEP} to get a first number (which may be a floating point number or an integer), then rounding the first number into an integer that is equal to or immediately adjacent to (e.g., differs by a magnitude less than 1) to the first number. Different methods for performing the rounding of the first number may be used. As an example, the integer number N may be determined by:

$$N = floor ( \frac{Δ V}{{V}_{STEP}} ) \qquad ( 2 )$$

where the floor(.) function rounds its input to the nearest integer toward negative infinity. In other words, Equation (2) finds the integer number N such that the new voltage value V_{IN} is the closest to the potential target voltage V_{TARGET} without going over (e.g., being larger than) the potential target voltage V_{TARGET}.

As another example, the integer number N may be determined by:

$$N = c e i l ( \frac{Δ V}{{V}_{STEP}} ) \qquad ( 3 )$$

where the ceil(.) function rounds its input to the nearest integer toward positive infinity. In other words, Equation (3) finds the integer number N such that the new voltage value V_{IN} is the closest to the potential target voltage V_{TARGET} without going under (e.g., being smaller than) the potential target voltage V_{TARGET}.

As yet another example, the integer number N may be determined by:

$$N = fix ( \frac{Δ V}{{V}_{STEP}} ) \qquad ( 4 )$$

where the fix(.) function rounds its input to the nearest integer toward zero. In some embodiments, a request to adjust the output voltage by N discrete steps is sent through the signal/data path 102 to the power source 101, and the power source 101 adjusts its output voltage by N discrete steps as requested. Note that in the illustrated embodiment, the new voltage value V_{IN} is not applied instantly as it is computed, instead, the new voltage value V_{IN} is applied later in a subsequent PID control loop (see, e.g., block 1130) to the power source 101 at the same time when a control signal v^{(j)} (see FIG. 3 and discussion thereof) is applied to the power conversion unit 11 to adjust the frequency or duty cycle of the PWM signal. Details are discussed hereinafter.

Next, in block 1120, a new target transmitter current I_{TARGET} is calculated by dividing the target transmitter power P_{TARGET} by the new voltage value V_{IN}:

$${I}_{TARGET} = \frac{{P}_{TARGET}}{{V}_{IN}} \qquad ( 5 )$$

Next, in block 1130, the new target transmitter current I_{TARGET} is used as an input to drive the power conversion circuit 11 such that the transmitter current generated by the power conversion circuit 111 approaches the new target transmitter current I_{TARGET}. In the illustrated embodiment, the new target transmitter current I_{TARGET} is used as an input to a Proportional-Integral-Differential (PID) control loop (see 330 in FIG. 3) to generate a control signal v^{(j)} (see v^{(j)} in FIG. 3), which control signal v^{(j)} is sent to the power conversion circuit 111 and is used to control the frequency or the duty cycle of the PWM signal generated by the PWM signal generator of the power conversion circuit 111, in order to adjust the transmitter current of the wireless power transmitter 110 to approach the new target transmitter current I_{TARGET}. The transmitter voltage of the wireless power transmitter 11o may also be adjusted (e.g., fine-tuned within a small range) by the frequency or duty cycle of the PWM signal, as skilled artisans readily appreciate. In some embodiments, after the transmitter current is adjusted by the PID control loop, the wireless power receiver 120 evaluates the charging power for its battery, and may send one or more additional power control commands to the wireless power transmitter 110 to fine-tune the transmitter power. Usually, within a few adjustments (e.g., a few power control commands), the charging power is within the desired range for the wireless power receiver 120.

In some embodiments, the PID control loop used for adjusting the transmitter power is the PID control loop defined in the Qi wireless charging standard, which is incorporated herein by reference. This allows re-use of the parameters and control algorithms defined in the Qi wireless charging standard, which simplifies the product design, reduces product cost, and shortens product development time significantly. For example, the disclosed method 1000 may be implemented by modifying the firmware (e.g., computer codes) developed for the Qi wireless charging standard, and the wireless power transmitter no can use the same simple hardware developed for the Qi wireless charging standard.

For each power control command received, the processing in blocks 1110, 1120, and 1130 achieves the target transmitter power V_{TARGET} by two adjustments: First, the DC voltage provided by the power source 101 is adjusted (e.g., in the PID control loop) by N discrete steps, which causes a corresponding change in the transmitter voltage (e.g., a voltage shift of N×V_{STEP}) generated by the power conversion circuit in, which in turn causes a change in the transmitter power. This change in the transmitter voltage satisfies a first portion (which may be a majority portion) of the required transmitter power change. Second, the transmitter current is adjusted by the control signal generated by a PID control loop (details discussed below with reference to FIG. 3), where the PID control loop uses the new target transmitter current I_{TARGET} to compute an error signal that drives the PID control loop. The adjustment of the transmitter current satisfies the remaining portion (which may be a minor portion) of the required transmitter power change. In some embodiments, the PID control loop adjusts the transmitter power by adjusting the frequency or duty cycle of the PWM signal, and therefore, has limited capability in adjusting the transmitter power. The presently disclosed method, by adjusting the output voltage of the power source 101, allows large adjustment of the transmitter power, and the remaining small adjustment needed in the transmitter power is taken care of by the PID control loop. By combining the coarse adjustment capability of the power source 101 and the fine-tuning adjustment capability of the PID control loop, a large transmitter power adjustment range is achieved while achieving smooth, highly accurate transmitter power control.

Still referring to FIG. 2, if the magnitude of the potential voltage change ΔV is smaller than the discrete step size V_{STEP}, the processing of the method 1000 proceeds to block 1050, where the potential voltage change ΔV (which may have a positive or negative value) is added to an accumulated voltage value V_{ACCU}. The accumulated voltage value V_{ACCU} is initialized to zero during a power up or a reset of the wireless power transmitter 110, and is changed by the potential voltage change ΔV during the processing of the block 1050, in some embodiments.

Next, in block 1060, the magnitude (e.g., the absolute value |ΔV_{ACCU}|) of the accumulated voltage value V_{ACCU} is compared with the discrete step size V_{STEP} of the power source 101, in order to determine if the magnitude of the accumulated voltage value V_{ACCU} is equal to or larger than the discrete step size V_{STEP}.

If the magnitude of the accumulated voltage value V_{ACCU} is equal to or larger than the discrete step size V_{STEP}, the processing proceeds to block 1070, where a new voltage value V_{IN} for the power source 101 is computed by adjusting the present value for the output voltage of the power source 101 by one discrete step size. In particular, if the accumulated voltage value V_{ACCU} has a positive value (e.g., V_{ACCU}≥V_{STEP}), then the new voltage value V_{IN} of the power source 101 is increased by one discrete step size of V_{STEP}, and the accumulated voltage value V_{ACCU} is assigned an updated value of V_{ACCU}−V_{STEP}. Conversely, if the accumulated voltage value V_{ACCU} has a negative value (e.g., V_{ACCU}≥−V_{STEP}), then the new voltage value V_{IN} is decreased by one discrete step size of V_{STEP}, and the accumulated voltage value V_{ACCU} is assigned an updated value of V_{ACCU}+V_{STEP}. Note that the new voltage value V_{IN} is applied to the power source 101 later, in the PID control loop (see block 1100).

Next, in block 1080, a new target transmitter current I_{TARGET} is calculated by dividing the target transmitter power P_{TARGET} by the new voltage value V_{IN} computed in block 1070, using Equation (5).

Next, in block 1100, the new target transmitter current I_{TARGET} is used to calculate the error signal that drives the PID control loop. In response to the error signal, the PID control loop generates a control signal v^{(j)} (see FIG. 3), which control signal controls the power conversion circuit 11 such that the transmitter current generated by the power conversion circuit 11 approaches the new target transmitter current I_{TARGET}. The processing is the same as or similar to that of block 1130, thus details are not repeated.

The processing in blocks 1060, 1070, and 1080 provides additional performance advantage. To appreciate the advantage, consider a scenario where multiple power control command are received, where each power control command corresponds to a respective small potential voltage change ΔV (e.g., smaller than one discrete step size V_{STEP}), and all of the power control commands request power adjustment in the same direction (e.g. power up or power down). Without the processing of blocks 1060, 1070, and 1080, the wireless power transmitter 110 may adjust only the frequency or duty cycle of the PWM signal in the power conversion circuit 11 to accommodate the requested transmit power change. However, adjusting only the frequency or duty cycle of the PWM signal can only achieve limited range of adjustment in the transmit power. If the sequence of power control commands all request “power up” or “power down,” then after responding to the first few power control commands, the power conversion circuit 11 may reach its maximum adjustment range (e.g., reaching the maximum frequency or duty cycle), and may not be able to accommodate additional power adjustment requests. The present disclosure, by combining multiple small power adjustment requests into one discrete step size change in the output voltage V_{IN} of the power source 101, ensures that the power conversion circuit 11 only have to accommodate small power adjustment requests within its adjusting capability, thereby ensuring smooth, well-regulated power adjustment.

If, in the processing of block 1060, the magnitude of the accumulated voltage value V_{ACCU} is determined to be smaller than the discrete step size V_{STEP}, the output voltage V_{IN} of the power source 101 is not changed (e.g., maintain the present value). The processing proceeds to block 1090, where a new target transmitter current I_{TARGET} is calculated by dividing the target transmitter power P_{TARGET} by the present value of the output voltage V_{IN}, using Equation (5).

Next, the processing proceeds to block 1100, where the new target transmitter current I_{TARGET} is used for control of the PID control loop. The processing of block 1100 has been discussed above, thus details are not repeated.

FIG. 3 illustrates a block diagram of a digital signal processing system 2000, in an embodiment. The functional blocks of the digital signal processing system 2000 are used to implement the various processing steps of the method 1000 of FIG. 2. In some embodiments, the digital signal processing system 2000 is implemented as the firmware running on the controller 113 of the wireless power transmitter 110.

As illustrated in FIG. 3, the digital signal processing system 2000 accepts a power control command c and generates a control signal v^{(j)} as its output, where the superscript (j) indicates the iteration number within the PID control loop 330, details of which are discussed hereinafter. For example, the power control command c represents the power control command received currently, and the control signal v^{(j)} is the j-th control signal calculated by the PID control loop 330 in response to the power control command received currently, where j=1, 2, . . . , M, and M is the total number of iterations of the PID control loop 330 in response to the power control command received currently. The control signal v^{(j)} contains control information, such as frequency or duty cycle of the PWM signal, and is sent to the power conversion circuit in to control the operation of the power conversion circuit in.

In FIG. 3, the block 310 may correspond to a power control command c relayed by the in-band communication circuit 117 to the controller 113. In the example of FIG. 3, the functional block 2010 receives the power control command c, which indicates a percentage change in the transmitter power, and scales the present value tₐ^{(j)} of the transmitter current by the requested percentage change to compute a target transmitter current value t_{d}^{(j)}. Next, in functional block 2020, the present value Vₐ^{(j)} of the transmitter voltage is multiplied with the target transmitter current value t_{d}^{(j)} to compute a target transmitter power P_{d}^{(j)}. Next, in functional block 2030, a potential target voltage V_{d}^{(j)} is computed by dividing the target transmitter power P_{d}^{(j)} by the target transmitter current value t_{d}^{(j)}.

Next, the functional block 2040 performs the processing in various processing steps of FIG. 2, such as the processing steps after the block 1030 but excluding the processing of “Run PID Loop” in blocks 1130 and 1100. For example, the functional block 2040 may perform the comparison step (e.g., blocks 1040/1060), the processing step of “Compute New V_{IN}” in FIG. 2 (e.g., blocks 1110/1070), and send a signal 2042, which indicates the integer number N of discrete voltage steps for the power source 101 to adjust its output voltage, to the power conversion circuit 11 (which then relays the integer number N to the power source 101). In addition, the functional block 2040 may perform the processing of “Compute New Target Current” of FIG. 2 (e.g., blocks 1090/1080/1120), and send a signal 2041, which indicates a new target current value t_{d}^{(j)}, to an adder 2050. The new target current value t_{d′}^{(j)} corresponds to the new target transmitter current I_{TARGET} discussed above, in some embodiments. The new target current value t_{d′}^{(j)} is used as an input to the PID control loop 330. Note that in the illustrated embodiment, the processing in functional blocks 2010, 2020, 2030, and 2040 are performed only once (when j=1) for the power control command received currently, and therefore, the new target current value t_{d′}^{(j)} is computed only once when j=1 and is used as the target value for the PID control loop 330. The PID control loop 330, however, may run multiple iterations (e.g., a total of M iterations) within a given period of time to generate the control signal v^{(j)} in each of the iterations, and the control signal v^{(j)} is used to adjust the frequency or duty cycle of the PWM signal of the power conversion unit 11 in each of the iterations. For example, in the j-th iteration, the present value tₐ^{(j)} of the transmitter current is subtracted from t_{d′}^{(j=1)} to generate an error signal e^{(j)}, which in turn generates a control signal v^{(j)} for the j-th iteration, as discussed below. Note that the notation t_{d′}^{(j=1)} is used here to clearly indicate that the new target current value t_{d′}^{(j)} is calculated only once when j=1 and is used for all of the M iterations of the PID control loop 330.

As illustrated in the FIG. 3, within the PID control loop 330, the adder 2050 computes an error signal e^{(j)} between the new target current value t_{d′}^{(j=1)} and the present value tₐ of the transmitter current. Next, the error signal e^{(j)} is used as an input signal to drive a PID controller functional block 2060 and to generate an output signal PID^{(j)}. The PID controller functional block 2060 may include a proportional control block, an integral control block, and a derivative control block to perform the PID control function, as an example. In some embodiments, the PID controller functional block 2060 uses the parameters and structure described in the Qi wireless charging standard. PID control is known in the art, thus details are not discussed here.

Next, in the functional block 2070, the output signal PID^{(j)} is scaled by a scaling factor Sᵥ, then the scaled value is subtracted from a previous value v^{(j-1)} (e.g., value in a previous iteration of the PID control loop) of the control signal to generate the control signal v^{(j)} as the output signal of the digital signal processing system 2000 (also referred to as the output of the PID control loop) in response to the power control command received. As discussed above, in some embodiments, the PID control loop 330 runs multiple iterations. During the j-th iteration, j=1, 2, . . . , M, a corresponding control signal v^{(j)} is generated to control the frequency or duty cycle of the PWM signal of the power conversion unit 111. Notably, the new voltage value V_{IN} for the power source 101 is applied at the same time when the control signal v^{(j)} is applied to the power conversion unit 111, as discussed above. In other words, the output voltage of the power source 101 is changed (if voltage change is needed as determined by the processing of FIG. 2) at the same time when the frequency or duty cycle of the PWM signal of the power conversion unit 11 are changed. In some embodiments, the signal 2042, which indicates the integer number N of discrete voltage steps for the power source 101 to adjust its output voltage, may be included within the control signal v^{(j)} as part of the control signal v^{(j)}.

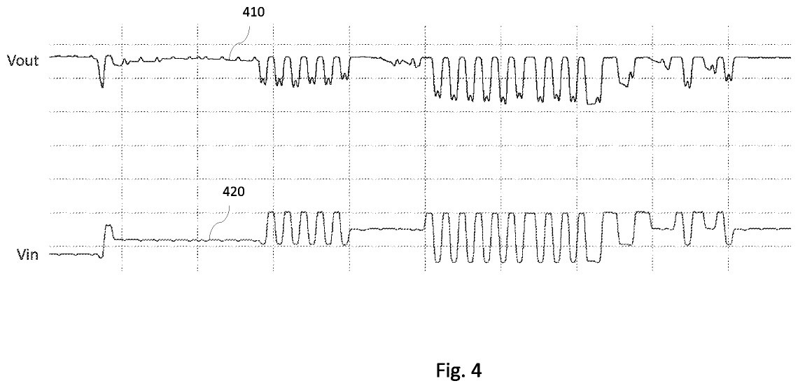

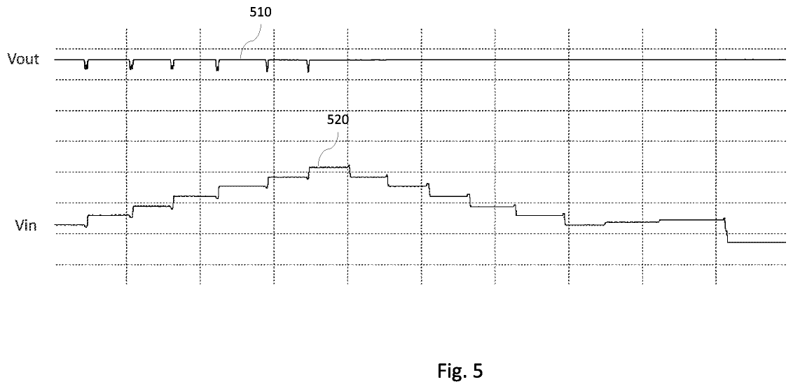

FIGS. 4 and 5 illustrate performance of a wireless charging system without and with the presently disclosed control method for the wireless power transmitter, respectively, in an embodiment. To generate the performance results of FIG. 4, a reference signal processing system is formed by modifying the digital signal processing system 2000 of FIG. 3 by removing the functional blocks in the dashed region 320 and by supplying the output signal t_{d}^{(j)} of the function block 2010 to the adder 2050 to replace the signal t_{d′}^{(j)}. The power source 101 used to obtain the performance results in FIGS. 4 and 5 is a USB-QC power supply with a discrete step size of 200 mV.

In FIG. 4, the curve 420 shows the voltage V_{IN} provided by the power source 101, and the curve 410 shows the output voltage V_{OUT} (e.g., voltage at the output of the voltage condition circuit 125) of the wireless power receiver 120. In the reference signal processing system, the output signal v^{(j)} of the PID control loop controls the voltage V_{IN} provided by the power source 101 and the frequency or duty cycle of the PWM signal of the power conversion circuit 11. A medium load condition of about 500 mA is simulated. As shown in the FIG. 4, without the disclosed control method, the coarse step size of 200 mV of the power source 101 is too large to achieve a smooth received voltage at a target level. In fact, as illustrated in FIG. 4, due to the coarse step size of 200 mV, oscillation in the output voltage V_{OUT} occurs as the wireless power receiver 120 sends power control commands that oscillate (e.g., alternate) between a “power up” request and a “power down” request. The large voltage spikes in the output voltage V_{OUT} due to the oscillation may be too large and may damage the rechargeable battery being charged by the output voltage V_{OUT}.

In FIG. 5, the curve 520 shows the voltage V_{IN} provided by the power source 101, and the curve 510 shows the output voltage V_{OUT} (e.g., voltage at the output of the voltage condition circuit 125) of the wireless power receiver 120. To generate the performance results of FIG. 5, the load is varied from 0 A to 1 A, and the method 1000 (implemented by the digital signal processing system 2000) is used to control the wireless power transmitter 110. As shown in FIG. 5, as the load sweeps from 0 A to 1 A, the voltage V_{IN} provided by the power source 101 changes from 5 V to 8 V in discrete step size of 200 mV, and a smooth output voltage V_{OUT} is observed throughout the process, with a maximum voltage dip of less than 140 mV.

Disclosed embodiments may achieve advantages. For example, the disclosed method 1000 adjusts the transmitter power by adjusting the output voltage of the power source 101 by one or more discrete steps when possible, and by adjusting the frequency or duty cycle of the PWM signal in the power conversion circuit 11. The disclosed method requires no hardware change in the wireless power transmitter, and allows the use of inexpensive, widely available power supply (e.g., USB-QC power supply) as the power source 101. The disclosed control method may be implemented as firmware running on the controller 113, and the firmware may re-use software modules previous designed for the PID control of the Qi wireless charging standard. The above features/advantages reduce cost of the wireless power transmitter and shorten product development time.

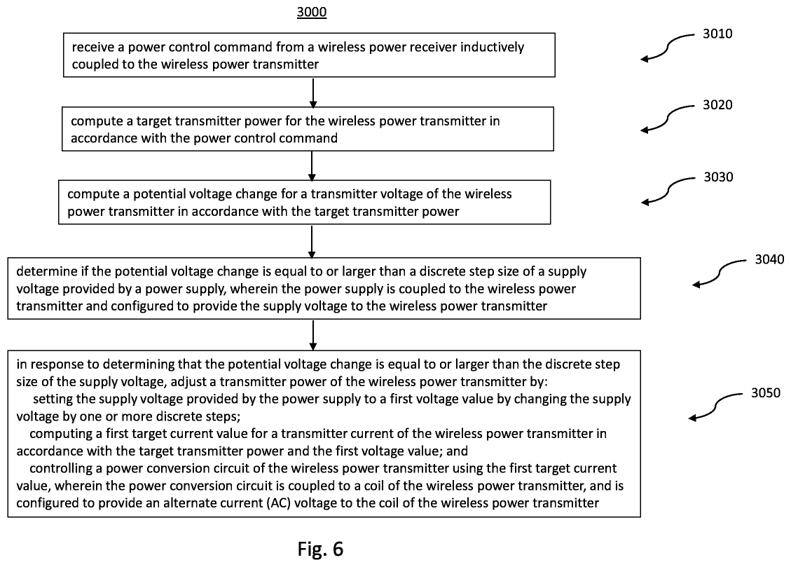

FIG. 6 illustrates a flow chart of a method 3000 for operating a wireless power transmitter, in an embodiment. It should be understood that the method 3000 shown in FIG. 6 is merely an example of many possible embodiment methods. One of ordinary skill in the art would recognize many variations, alternatives, and modifications. For example, various steps as illustrated in FIG. 6 may be added, removed, replaced, rearranged, or repeated.

Referring to FIG. 6, at block 3010, a power control command is received from a wireless power receiver inductively coupled to the wireless power transmitter. At block 3020, a target transmitter power for the wireless power transmitter is computed in accordance with the power control command. At block 3030, a potential voltage change for a transmitter voltage of the wireless power transmitter is computed in accordance with the target transmitter power. At block 3040, whether the potential voltage change is equal to or larger than a discrete step size of a supply voltage provided by a power supply is determined, wherein the power supply is coupled to the wireless power transmitter and configured to provide the supply voltage to the wireless power transmitter. At block 3050, in response to determining that the potential voltage change is equal to or larger than the discrete step size of the supply voltage, a transmitter power of the wireless power transmitter is adjusted by: setting the supply voltage provided by the power supply to a first voltage value by changing the supply voltage by one or more discrete steps; computing a first target current value for a transmitter current of the wireless power transmitter in accordance with the target transmitter power and the first voltage value; and controlling a power conversion circuit of the wireless power transmitter using the first target current value, wherein the power conversion circuit is coupled to a coil of the wireless power transmitter, and is configured to provide an alternate current (AC) voltage to the coil of the wireless power transmitter.

Example embodiments of the present invention are summarized here. Other embodiments can also be understood from the entirety of the specification and the claims filed herein.

Example 1. In an embodiment, a method for operating a wireless power transmitter includes: receiving a power control command from a wireless power receiver inductively coupled to the wireless power transmitter; computing a target transmitter power for the wireless power transmitter in accordance with the power control command; computing a potential voltage change for a transmitter voltage of the wireless power transmitter in accordance with the target transmitter power; determining if a magnitude of the potential voltage change is equal to or larger than a discrete step size of a supply voltage provided by a power supply, wherein the power supply is coupled to the wireless power transmitter and configured to provide the supply voltage to the wireless power transmitter; and in response to determining that the magnitude of the potential voltage change is equal to or larger than the discrete step size of the supply voltage, adjusting a transmitter power of the wireless power transmitter by: setting the supply voltage provided by the power supply to a first voltage value by changing the supply voltage by one or more discrete steps; computing a first target current value for a transmitter current of the wireless power transmitter in accordance with the target transmitter power and the first voltage value; and controlling a power conversion circuit of the wireless power transmitter using the first target current value, wherein the power conversion circuit is coupled to a coil of the wireless power transmitter, and is configured to provide an alternate current (AC) voltage to the coil of the wireless power transmitter.

Example 2. The method of Example 1, wherein the power supply is a direct current (DC) power supply configured to provide a DC voltage, and the power conversion circuit is configured to convert the DC voltage provided by the power supply into the AC voltage applied to the coil of the wireless power transmitter.

Example 3. The method of Example 2, wherein the power supply is a Universal Serial Bus-Dedicated Charging Port (USB-DCP) power supply.

Example 4. The method of Example 3, wherein controlling the power conversion circuit comprises: computing an error signal by calculating a difference between the first target current value and a present value of the transmitter current; generating a control signal by processing the error signal using a Proportional-Integral-Differential (PID) control block; and controlling the power conversion circuit of the wireless power transmitter using the control signal.

Example 5. The method of Example 1, wherein computing the potential voltage change comprises: obtaining present values for the transmitter current and the transmitter voltage of the wireless power transmitter; dividing the target transmitter power by the present value of the transmitter current to obtain a potential target voltage for the wireless power transmitter; and calculating a voltage difference between the potential target voltage and the present value of the transmitter voltage.

Example 6. The method of Example 5, wherein setting the supply voltage comprises: dividing the voltage difference by the discrete step size of the supply voltage to obtain a first number; rounding the first number to an integer number that is equal to or immediately adjacent to the first number; and shifting the supply voltage by the integer number of discrete steps to set the supply voltage to the first voltage value.

Example 7. The method of Example 1, further comprising, in response to determining that the magnitude of the potential voltage change is smaller than the discrete step size of the supply voltage, adjusting the transmitter power of the wireless power transmitter by: accumulating the potential voltage change by adding the potential voltage change to an accumulated value; and comparing the accumulated value with the discrete step size of the supply voltage.

Example 8. The method of Example 7, further comprising, in response to determining that a magnitude of the accumulated value is smaller than the discrete step size of the supply voltage: keeping the supply voltage provided by the power supply unchanged at a present value of the supply voltage; computing a second target current value for the transmitter current of the wireless power transmitter in accordance with the target transmitter power and the present value of the supply voltage; and controlling the power conversion circuit of the wireless power transmitter using the second target current value.

Example 9. The method of Example 7, further comprising, in response to determining that a magnitude of the accumulated value is equal to or larger than the discrete step size of the supply voltage: setting the supply voltage provided by the power supply to a second voltage value by shifting the supply voltage by the discrete step size; computing a third target current value for the transmitter current of the wireless power transmitter in accordance with the target transmitter power and the second voltage value; and controlling the power conversion circuit of the wireless power transmitter using the third target current value.

Example 10. The method of Example 1, wherein setting the supply voltage and controlling the power conversion circuit are performed at the same time.

Example 11. The method of Example 1, wherein the power conversion circuit comprises a Pulse Width Modulation (PWM) signal generator and a DC-AC converter driven by a PWM signal generated by the PWM signal generator, wherein controlling the power conversion circuit comprises controlling a frequency or a duty cycle of the PWM signal.

Example 12. In an embodiment, a method for operating a wireless power transmitter includes: receiving, by the wireless power transmitter, a power control command from a wireless power receiver, wherein the wireless power transmitter comprises a power conversion circuit, wherein the power conversion circuit is coupled to a Direct Current (DC) power supply and is configured to convert a DC voltage provided by the DC power supply into an Alternate Current (AC) voltage applied to a coil of the wireless power transmitter, wherein the DC voltage provided by the DC power supply changes in discrete steps and has a discrete step size; computing a target transmitter power for the wireless power transmitter in accordance with the power control command; computing, based on the target transmitter power and a present value of a transmitter current of the wireless power transmitter, a potential voltage change for a transmitter voltage of the wireless power transmitter in order to achieve the target transmitter power; determining if a magnitude of the potential voltage change is equal to or larger than the discrete step size of the DC power supply; and in response to determining that the magnitude of the potential voltage change is equal to or larger than the discrete step size of the DC power supply, adjusting a transmitter power of the wireless power transmitter by: shifting the DC voltage provided by the DC power supply by one or more discrete steps such that the DC voltage has a first voltage value; computing a first target current value for the transmitter current of the wireless power transmitter based on the target transmitter power and the first voltage value; and controlling the power conversion circuit using the first target current value.

Example 13. The method of Example 12, wherein the DC power supply is a Universal Serial Bus-Dedicated Charging Port (USB-DCP) compliant power supply, wherein controlling the power conversion circuit comprises: generating an error signal using the first target current value and the present value of the transmitter current; and feeding the error signal to a Proportional-Integral-Differential (PID) control block to generate a control signal for the power conversion circuit, wherein the PID control block is in compliance with the Qi wireless charging standard.

Example 14. The method of Example 12, further comprising, in response to determining that the magnitude of the potential voltage change is smaller than the discrete step size of the DC power supply, adjusting the transmitter power of the wireless power transmitter by: accumulating the potential voltage change by adding the potential voltage change to an accumulated value; comparing the accumulated value with the discrete step size of the DC power supply; and in response to determining that a magnitude of the accumulated value is smaller than the discrete step size of the DC power supply: keeping the DC voltage provided by the DC power supply unchanged at a present value of the DC voltage; computing a second target current value for the transmitter current of the wireless power transmitter based on the target transmitter power and the present value of the DC voltage; and controlling the power conversion circuit using the second target current value.

Example 15. The method of Example 14, further comprising, in response to determining that the magnitude of the accumulated value is equal to or larger than the discrete step size of the DC power supply: shifting the DC voltage provided by the DC power supply by a discrete step such that the DC voltage has a second voltage value; computing a third target current value for the transmitter current of the wireless power transmitter based on the target transmitter power and the second voltage value; and controlling the power conversion circuit using the third target current value.

Example 16. The method of Example 12, wherein the power control command comprises a request from the wireless power receiver, wherein the request indicates a percentage change required in the transmitter power of the wireless power transmitter.

Example 17. The method of Example 16, wherein computing the target transmitter power comprises: computing a modified current value by changing the present value of the transmitter current by the percentage change indicated in the power control command; and multiplying the modified current value with a present value of the transmitter voltage of the wireless power transmitter.

Example 18. In an embodiment, a wireless power transmitter includes: a coil; a power conversion circuit coupled to the coil, wherein the power conversion circuit is configured to receive a Direct Current (DC) voltage from a power supply and convert the DC voltage to an Alternate Current (AC) voltage applied to the coil, wherein DC voltage provided by the power supply is adjustable in discrete steps and has a discrete step size; a communication circuit coupled to the coil and configured to receive a power control command from a wireless power receiver; and a controller coupled to the power conversion circuit and the communication circuit, wherein the controller is configured to: receive the power control command from the communication circuit; compute a target transmitter power for the wireless power transmitter in accordance with the power control command; compute, based on the target transmitter power and a present value of a transmitter current of the wireless power transmitter, a potential voltage change for a transmitter voltage of the wireless power transmitter; compare the potential voltage change with the discrete step size of the power supply; and in response to determining that a magnitude of the potential voltage change is equal to or larger than the discrete step size of the power supply, adjust a transmitter power of the wireless power transmitter by: shifting the DC voltage provided by the power supply by one or more discrete steps such that the DC voltage has a first voltage value; computing a first target current value for the transmitter current of the wireless power transmitter based on the target transmitter power and the first voltage value; and controlling the power conversion circuit using the first target current value.

Example 19. The wireless power transmitter of Example 18, further comprising a feedback circuit couple to the coil and configured to measure present values of the transmitter current and the transmitter voltage.

Example 20. The wireless power transmitter of Example 18, wherein the power conversion circuit comprises a Pulse Width Modulation (PWM) signal generator and a DC-AC converter driven by a PWM signal generated by the PWM signal generator, wherein controlling the power conversion circuit comprises controlling a frequency or a duty cycle of the PWM signal.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for operating a wireless power transmitter, the method comprising:
receiving a power control command from a wireless power receiver inductively coupled to the wireless power transmitter;
computing a target transmitter power for the wireless power transmitter in accordance with the power control command;
computing a potential voltage change for a transmitter voltage of the wireless power transmitter in accordance with the target transmitter power;
determining if a magnitude of the potential voltage change is equal to or larger than a discrete step size of a supply voltage provided by a power supply, wherein the power supply is coupled to the wireless power transmitter and configured to provide the supply voltage to the wireless power transmitter; and
in response to determining that the magnitude of the potential voltage change is equal to or larger than the discrete step size of the supply voltage, adjusting a transmitter power of the wireless power transmitter by:
setting the supply voltage provided by the power supply to a first voltage value by changing the supply voltage by one or more discrete steps;
computing a first target current value for a transmitter current of the wireless power transmitter in accordance with the target transmitter power and the first voltage value; and
controlling a power conversion circuit of the wireless power transmitter using the first target current value, wherein the power conversion circuit is coupled to a coil of the wireless power transmitter, and is configured to provide an alternate current (AC) voltage to the coil of the wireless power transmitter.

2. The method of claim 1, wherein the power supply is a direct current (DC) power supply configured to provide a DC voltage, and the power conversion circuit is configured to convert the DC voltage provided by the power supply into the AC voltage applied to the coil of the wireless power transmitter.

3. The method of claim 2, wherein the power supply is a Universal Serial Bus-Dedicated Charging Port (USB-DCP) power supply.

4. The method of claim 3, wherein controlling the power conversion circuit comprises:
computing an error signal by calculating a difference between the first target current value and a present value of the transmitter current;
generating a control signal by processing the error signal using a Proportional-Integral-Differential (PID) control block; and
controlling the power conversion circuit of the wireless power transmitter using the control signal.

5. The method of claim 1, wherein computing the potential voltage change comprises:
obtaining present values for the transmitter current and the transmitter voltage of the wireless power transmitter;
dividing the target transmitter power by the present value of the transmitter current to obtain a potential target voltage for the wireless power transmitter; and
calculating a voltage difference between the potential target voltage and the present value of the transmitter voltage.

6. The method of claim 5, wherein setting the supply voltage comprises:
dividing the voltage difference by the discrete step size of the supply voltage to obtain a first number;
rounding the first number to an integer number that is equal to or immediately adjacent to the first number; and
shifting the supply voltage by the integer number of discrete steps to set the supply voltage to the first voltage value.

7. The method of claim 1, further comprising, in response to determining that the magnitude of the potential voltage change is smaller than the discrete step size of the supply voltage, adjusting the transmitter power of the wireless power transmitter by:
accumulating the potential voltage change by adding the potential voltage change to an accumulated value; and
comparing the accumulated value with the discrete step size of the supply voltage.

8. The method of claim 7, further comprising, in response to determining that a magnitude of the accumulated value is smaller than the discrete step size of the supply voltage:
keeping the supply voltage provided by the power supply unchanged at a present value of the supply voltage;
computing a second target current value for the transmitter current of the wireless power transmitter in accordance with the target transmitter power and the present value of the supply voltage; and
controlling the power conversion circuit of the wireless power transmitter using the second target current value.

9. The method of claim 7, further comprising, in response to determining that a magnitude of the accumulated value is equal to or larger than the discrete step size of the supply voltage:
setting the supply voltage provided by the power supply to a second voltage value by shifting the supply voltage by the discrete step size;
computing a third target current value for the transmitter current of the wireless power transmitter in accordance with the target transmitter power and the second voltage value; and
controlling the power conversion circuit of the wireless power transmitter using the third target current value.

10. The method of claim 1, wherein setting the supply voltage and controlling the power conversion circuit are performed at the same time.

11. The method of claim 1, wherein the power conversion circuit comprises a Pulse Width Modulation (PWM) signal generator and a DC-AC converter driven by a PWM signal generated by the PWM signal generator, wherein controlling the power conversion circuit comprises controlling a frequency or a duty cycle of the PWM signal.

12. A method for operating a wireless power transmitter, the method comprising:
receiving, by the wireless power transmitter, a power control command from a wireless power receiver, wherein the wireless power transmitter comprises a power conversion circuit, wherein the power conversion circuit is coupled to a Direct Current (DC) power supply and is configured to convert a DC voltage provided by the DC power supply into an Alternate Current (AC) voltage applied to a coil of the wireless power transmitter, wherein the DC voltage provided by the DC power supply changes in discrete steps and has a discrete step size;
computing a target transmitter power for the wireless power transmitter in accordance with the power control command;
computing, based on the target transmitter power and a present value of a transmitter current of the wireless power transmitter, a potential voltage change for a transmitter voltage of the wireless power transmitter in order to achieve the target transmitter power;
determining if a magnitude of the potential voltage change is equal to or larger than the discrete step size of the DC power supply; and
in response to determining that the magnitude of the potential voltage change is equal to or larger than the discrete step size of the DC power supply, adjusting a transmitter power of the wireless power transmitter by:
shifting the DC voltage provided by the DC power supply by one or more discrete steps such that the DC voltage has a first voltage value;
computing a first target current value for the transmitter current of the wireless power transmitter based on the target transmitter power and the first voltage value; and
controlling the power conversion circuit using the first target current value.

13. The method of claim 12, wherein the DC power supply is a Universal Serial Bus-Dedicated Charging Port (USB-DCP) compliant power supply, wherein controlling the power conversion circuit comprises:
generating an error signal using the first target current value and the present value of the transmitter current; and
feeding the error signal to a Proportional-Integral-Differential (PID) control block to generate a control signal for the power conversion circuit, wherein the PID control block is in compliance with the Qi wireless charging standard.

14. The method of claim 12, further comprising, in response to determining that the magnitude of the potential voltage change is smaller than the discrete step size of the DC power supply, adjusting the transmitter power of the wireless power transmitter by:
accumulating the potential voltage change by adding the potential voltage change to an accumulated value;
comparing the accumulated value with the discrete step size of the DC power supply; and
in response to determining that a magnitude of the accumulated value is smaller than the discrete step size of the DC power supply:
keeping the DC voltage provided by the DC power supply unchanged at a present value of the DC voltage;
computing a second target current value for the transmitter current of the wireless power transmitter based on the target transmitter power and the present value of the DC voltage; and
controlling the power conversion circuit using the second target current value.

15. The method of claim 14, further comprising, in response to determining that the magnitude of the accumulated value is equal to or larger than the discrete step size of the DC power supply:
shifting the DC voltage provided by the DC power supply by a discrete step such that the DC voltage has a second voltage value;
computing a third target current value for the transmitter current of the wireless power transmitter based on the target transmitter power and the second voltage value; and
controlling the power conversion circuit using the third target current value.

16. The method of claim 12, wherein the power control command comprises a request from the wireless power receiver, wherein the request indicates a percentage change required in the transmitter power of the wireless power transmitter.

17. The method of claim 16, wherein computing the target transmitter power comprises:
computing a modified current value by changing the present value of the transmitter current by the percentage change indicated in the power control command; and
multiplying the modified current value with a present value of the transmitter voltage of the wireless power transmitter.

18. A wireless power transmitter comprising:
a coil;
a power conversion circuit coupled to the coil, wherein the power conversion circuit is configured to receive a Direct Current (DC) voltage from a power supply and convert the DC voltage to an Alternate Current (AC) voltage applied to the coil, wherein DC voltage provided by the power supply is adjustable in discrete steps and has a discrete step size;
a communication circuit coupled to the coil and configured to receive a power control command from a wireless power receiver; and
a controller coupled to the power conversion circuit and the communication circuit, wherein the controller is configured to:
receive the power control command from the communication circuit;
compute a target transmitter power for the wireless power transmitter in accordance with the power control command;
compute, based on the target transmitter power and a present value of a transmitter current of the wireless power transmitter, a potential voltage change for a transmitter voltage of the wireless power transmitter;
compare the potential voltage change with the discrete step size of the power supply; and
in response to determining that a magnitude of the potential voltage change is equal to or larger than the discrete step size of the power supply, adjust a transmitter power of the wireless power transmitter by:
shifting the DC voltage provided by the power supply by one or more discrete steps such that the DC voltage has a first voltage value;
computing a first target current value for the transmitter current of the wireless power transmitter based on the target transmitter power and the first voltage value; and
controlling the power conversion circuit using the first target current value.

19. The wireless power transmitter of claim 18, further comprising a feedback circuit couple to the coil and configured to measure present values of the transmitter current and the transmitter voltage.

20. The wireless power transmitter of claim 18, wherein the power conversion circuit comprises a Pulse Width Modulation (PWM) signal generator and a DC-AC converter driven by a PWM signal generated by the PWM signal generator, wherein controlling the power conversion circuit comprises controlling a frequency or a duty cycle of the PWM signal.
